(19) United States
(12) Patent Application Publication
(10) Pub. No.: US 2010/0242078 A1
(43) Pub. Date: Sep. 23, 2010

(54) APPARATUS AND METHOD FOR USE IN A MOBILE/HANDHELD COMMUNICATIONS SYSTEM

(76) Inventors: Wen Gao, West Winsor, NJ (US); Benyuan Zhang, Cherry Hill, NJ (US); Paul Knutson, Lawrenceville, NJ (US)

Correspondence Address: Robert D. Shedd, Patent Operations;THOMSON Licensing LLC, P.O. Box 5312, Princeton, NJ, 08543-5312, US

(21) Appl. No.: 12/452,160

(22) PCT Filed: Jun. 20, 2008
(86) PCT No.: PCT/US08/07669

§ 371 Date: May 20, 2010

Related U.S. Application Data
(60) Provisional application No. 60/936,764, filed on Jun. 21, 2007.
(60) Provisional application No. 60/958,542, filed on Jul. 6, 2007.

(51) Int. Cl. H04N 7/173

(52) U.S. Cl. 725/112

(57) ABSTRACT

An Advanced Television Systems Committee Digital Television (ATSC DTV) transmitter transmits a digital multiplex that includes a legacy DTV channel and a mobile DTV channel. The mobile DTV channel is conveyed in mobile packets that comprise mobile data and additional mobile training information. A mobile packet comprises 207 bytes wherein 2 bytes are header information, 20 bytes are Reed-Solomon (RS) parity information and 185 bytes convey mobile data and mobile training information. The mobile training information is inserted into mobile packets such that the additional training information appears in contiguous positions after convolutional interleaving.

### CROSS-REFERENCE TO RELATED APPLICATIONS

This application claims the benefit of U.S. Provisional Application No. 60/936,764, filed Jun. 21, 2007 and U.S. Provisional Application No. 60/958,542, filed Jul. 6, 2007.

### BACKGROUND OF THE INVENTION

The present invention generally relates to communications systems and, more particularly, to wireless systems, e.g., terrestrial broadcast, cellular, Wireless-Fidelity (Wi-Fi), satellite, etc.

The ATSC DTV (Advanced Television Systems Committee Digital Television) system (e.g., see, United States Advanced Television Systems Committee, “ATSC Digital Television Standard”, Document A/53, Sep. 16, 1995 and “Guide to the Use of the ATSC Digital Television Stlandard”, Document A/54, Oct. 4, 1995) offers about 19 Mbits/sec (millions of bits per second) for transmission of an MPEG2-compressed HDTV (high definition TV) signal (MPEG2 refers to Moving Picture Expert Group (MPEG)-2 Systems Standard (ISO/IEC 13818-1)). As such, around four to six TV channels can be supported in a single physical transmission channel (PTC) without congestion. Additionally, excess bandwidth remains within this transport stream to provide for additional services. In fact, due to improvements in both MPEG2 encoding and the introduction of advanced codec (coder/decoder) technology (such as H.264 or VC1), even more additional spare capacity is becoming available in a PTC.

However, the ATSC DTV system was designed for fixed reception and performs poorly in a mobile environment. In this regard, there has been strong interest in developing an ATSC DTV system for mobile and handheld (M/H) devices while maintaining backward compatibility with the existing ATSC DTV system. In particular, in the ATSC DTV Mobile/Handheld (M/H) system, mobile data, e.g., programs (e.g., TV shows), are transmitted using some of the above-noted excess bandwidth in an ATSC PTC. This also enables “time-slicing”, so that the receiver of the handheld device only has to power up when receiving the mobile data—thus enabling the receiver to remain idle at other times and thereby reduce power consumption from the battery of the handheld device.

### SUMMARY OF THE INVENTION

In an ATSC DTV signal, the field sync sequence is used as the training sequence for converging an equalizer of the receiver, where the equalizer compensates for channel distortion. However, in a mobile environment, the channel is more dynamic than in a fixed environment. As such, the equalizer in a mobile receiver needs to converge quickly to track the dynamic channel. Unfortunately, we have observed that the ATSC DTV field sync sequence occurs too infrequently for the equalizer of the receiver to quickly converge in a mobile environment. In particular, the field sync sequence occurs at a rate of one field-sync sequence per field (24.2 milli-seconds (ms)). While the data segment sync occurs more frequently, at a rate of one segment sync sequence per data segment (77.3 micro-seconds (μsec.)), the data segment sync consists of only 4 symbols. Therefore, and in accordance with the principles of the invention, mobile packets carry mobile data and additional mobile training information.

In an illustrative embodiment of the invention, an Advanced Television Systems Committee Digital Television (ATSC DTV) transmitter transmits a digital multiplex that includes a legacy DTV channel and a mobile DTV channel. The mobile DTV channel is conveyed in mobile packets that comprise mobile data and additional mobile training information. A mobile packet comprises 207 bytes wherein 2 bytes are header information, 20 bytes are Reed-Solomon (RS) parity information and 185 bytes convey mobile data and mobile training information. The mobile training information is inserted into mobile packets such that the additional training information appears in contiguous positions after convolutional interleaving.

In an illustrative embodiment of the invention, an Advanced Television Systems Committee Digital Television (ATSC DTV) mobile, or handheld, device comprises a receiver for receiving a digital multiplex that includes a legacy DTV channel and a mobile DTV channel. The mobile DTV channel is conveyed in mobile packets that comprise mobile data and additional mobile training information. A mobile packet comprises 207 bytes wherein 2 bytes are header information, 20 bytes are Reed-Solomon (RS) parity information and 185 bytes convey mobile data and mobile training information. The mobile training information is inserted into mobile packets such that the additional training information appears in contiguous positions after convolutional interleaving.

In view of the above, and as will be apparent from reading the detailed description, other embodiments and features are also possible and fall within the principles of the invention.

### BRIEF DESCRIPTION OF THE DRAWINGS

FIGS. 1 and 2 show a prior art ATSC transmitter;

FIGS. 3, 4 and 5 show a format for an ATSC DTV signal;

FIG. 6 shows a prior art ATSC receiver;

FIG. 7 shows a mobile data packet in accordance with the principles of the invention;

FIG. 8 shows an illustrative mobile data field in accordance with the principles of the invention;

FIG. 9 shows an illustrative mobile field sync in accordance with the principles of the invention;

FIG. 10 shows an illustrative mobile transmission sequence;

FIGS. 11 and 12 show an illustrative embodiment of a transmitter in accordance with the principles of the invention;

FIG. 13 shows Table One entitled Data Capacity of a Mobile Burst in FEC Code Blocks as a Function of the Training Mode and the Number of Mobile Slices Contained in a Burst;

FIG. 14 illustrates the location of training data in a mobile slice as a function of packet index and byte index;

FIG. 15 shows Table Two entitled Available Data Capacity as a Function of the Training Mode and the Number of Mobile Slices Contained in a Burst;

FIGS. 16 and 17 show the mobile control channel information;

FIG. 18 shows an illustrative flow chart for use in a transmitter in accordance with the principles of the invention;

FIG. 19 shows an illustrative embodiment of an apparatus in accordance with the principles of the invention;

FIG. 20 shows an illustrative embodiment of a receiver in accordance with the principles of the invention;

FIG. 21 shows an illustrative flow chart for use in a receiver in accordance with the principles of the invention;

FIG. 22 shows adjacent network synchronization in accordance with the principles of the invention;

FIG. 23 shows translator synchronization in accordance with the principles of the invention;

FIG. 24 shows another illustrative flow chart for use in a receiver in accordance with the principles of the invention;

FIG. 25 shows network synchronization in accordance with the principles of the invention;

FIG. 26 shows another illustrative flow chart for use in a receiver in accordance with the principles of the invention; and

FIGS. 27 and 28 shows an alternate form of training, where the training data after interleaving is punctured four times across a packet.

### DETAILED DESCRIPTION

Other than the inventive concept, the elements shown in the figures are well known and will not be described in detail. Also, familiarity with television broadcasting, receivers and video encoding is assumed and is not described in detail herein. For example, other than the inventive concept, familiarity with current and proposed recommendations for TV standards such as NTSC (National Television Systems Committee), PAL (Phase Alternation Lines), SECAM (SEquential Couleur Avec Memoire), ATSC (Advanced Television Systems Committee), Digital Video Broadcasting (DVB), Digital Video Broadcasting-Terrestrial (DVB-T) (e.g., see ETSI EN 300 744 V1.4.1 (2001-01), Digital Video Broadcasting (DVB); Framing structure, channel coding and modulation for digital terrestrial television and the Chinese Digital Television System (GB) 20600-2006 (Digital Multimedia Broadcasting—Terrestrial/Handheld (DMB-T/H)) is assumed. Further information on ATSC broadcast signals can be found in the following ATSC standards: Digital Television Standard (A/53), Revision C, including Amendment No. 1 and Corrigendum No. 1, Doc. A/53C; and Recommended Practice: Guide to the Use of the ATSC Digital Television Standard (A/54). Likewise, other than the inventive concept, transmission concepts such as eight-level vestigial sideband (8-VSB), Quadrature Amplitude Modulation (QAM), orthogonal frequency division multiplexing (OFDM) or coded OFDM (COFDM)), and receiver components such as a radio-frequency (RF) front-end, or receiver section, such as a low noise block, tuners, and demodulators, correlators, leak integrators and squarers is assumed. Similarly, other than the inventive concept, formatting and encoding methods (such as Moving Picture Expert Group (MPEG)-2 Systems Standard (ISO/IEC 13818-1)) for generating transport bit streams are well-known and not described herein. It should also be noted that the inventive concept may be implemented using conventional programming techniques, which, as such, will not be described herein. Finally, like-numbers on the figures represent similar elements.

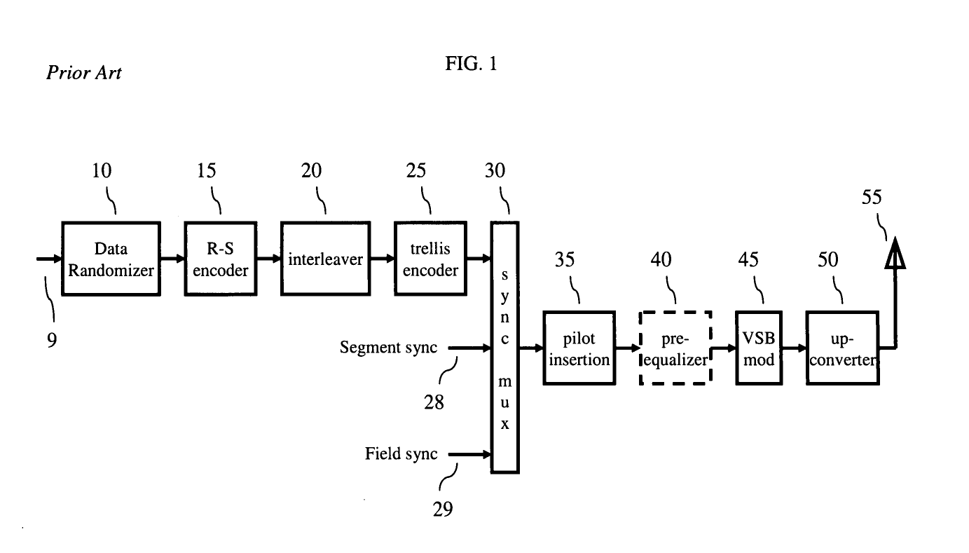

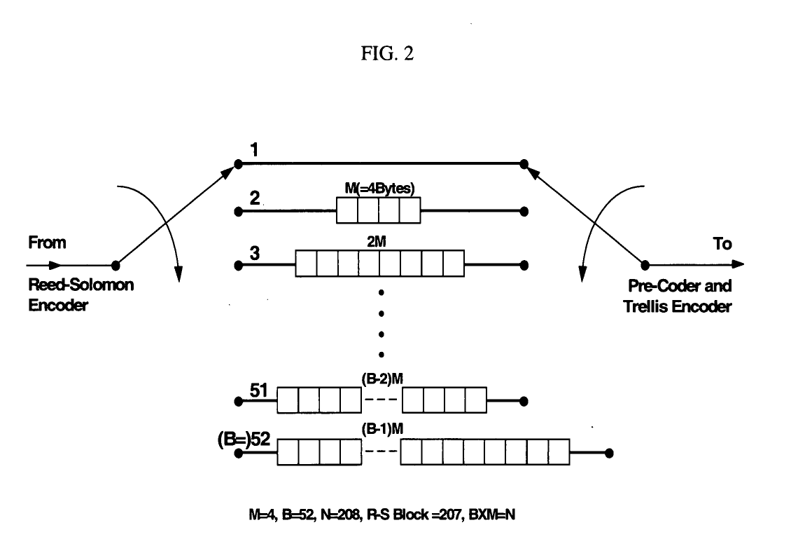

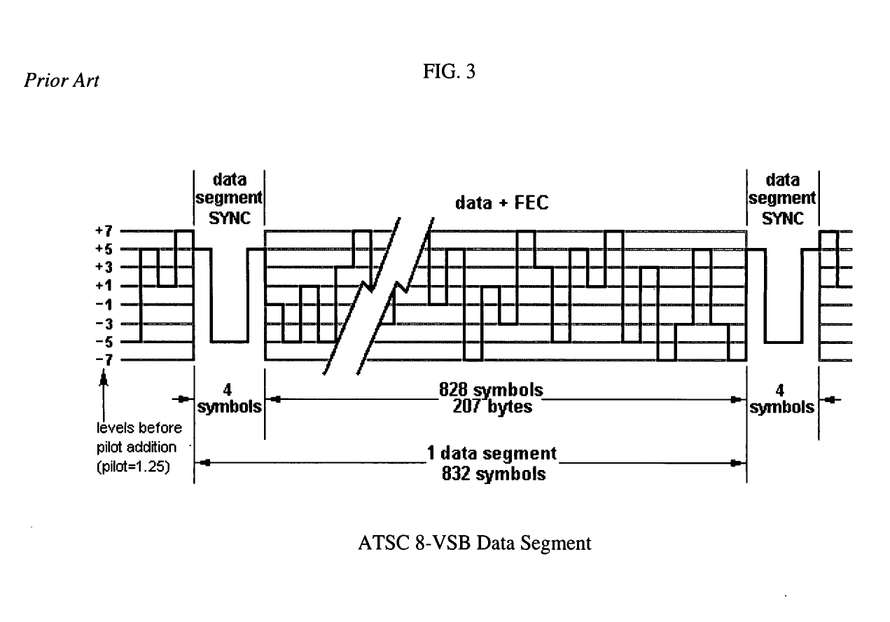

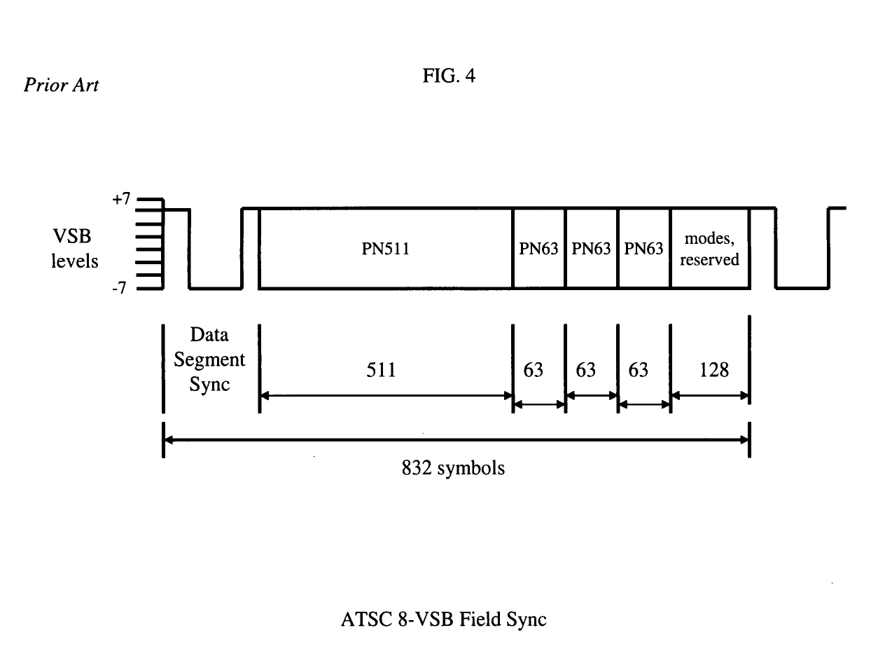

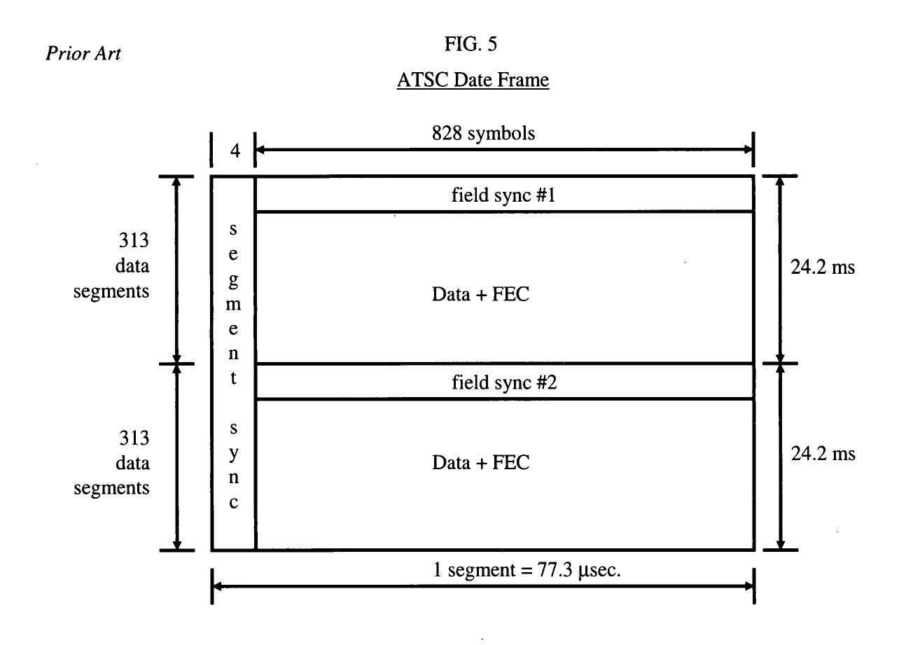

FIG. 1 shows today's ATSC transmitter, the elements of which are known and not described herein (e.g., see Advanced Television Standards Committee, ATSC Digital Television Standard, ATSC A/53E, April 2006). A stream of MPEG-2 transport packets 9 convey the data (e.g., video, audio, program and system information (PSIP)) in an ATSC DTV system. Each MPEG-2 transport packet contains 187 data bytes plus a sync byte. The sync byte is discarded in the ATSC transmitter and the 187 payload bytes are randomized through data randomizer 10 and encoded through a (187, 207) Reed-Solomon (R-S) encoder 15. As a result of the Reed-Solomon encoding, each MPEG-2 packet is padded with 20 parity bytes, and is then applied to convolutional interleaver 20, which provides interleaved data to rate ⅔ trellis encoder 25. Interleaver 20 as defined in ATSC Digital Television Standard, ATSC A/53E, April 2006 is shown in FIG. 2. The trellis encoded signal is then applied to sync multiplexer (mux) 30, which multiplexes the trellis encoded data with a data segment sync 28 and a field sync 29 to form ATSC data segments. In particular, ATSC symbols are transmitted in data segments. An ATSC data segment is shown in FIG. 3. The ATSC data segment comprises 832 symbols: four symbols for data segment sync, and 828 data symbols. As can be observed from FIG. 3, the data segment sync is inserted at the beginning of each data segment. The data segment sync is a two-level (binary) four-symbol sequence representing a binary 1001 pattern. Multiple data segments (313 segments) comprise an ATSC data field, which comprises a total of 260,416 symbols (832×313). The first data segment in a data field is called the field sync segment. The structure of the field sync segment is shown in FIG. 4, where each symbol represents one bit of data (two-level). In the field sync segment, a pseudo-random sequence of 511 bits (PN511) immediately follows the data segment sync. After the PN511 sequence, there are three identical pseudo-random sequences of 63 bits (PN63) concatenated together, with the second PN63 sequence being inverted every other data field. There are two data fields in an ATSC data frame, which is shown in FIG. 5.

In summary, a transport packet for ATSC comprises 188 bytes, including a sync byte. As noted above, the sync byte is stripped off, leaving 187 bytes. Then 20 bytes are added for Reed-Solomon error correction, giving 207 bytes per packet. The total number of bits is 1656 bits. The trellis coding—with a coding rate of ⅔—increases this to 2,484 bits, or 828 symbols, since eight-level coding gives three bits per symbol. A special waveform, known as the data segment sync, is added to the head of this packet and occupies four normal symbol periods. The total modified transmission stream packet now occupies 832 symbol periods, or a total time of 77.3 μs at the symbol rate of 10.76 megasymbols per second. This resulting new data packet is now called a data segment. Turning back to FIG. 1, after pilot insertion (35) and VSB modulation (mod) 45, the VSB-modulated symbols are up-converted to an RF TV channel via up-converter 50 for transmission of the ATSC DTV signal via antenna 55. It can be observed from FIG. 1 that an optional pre-equalizer 40 can also be used in forming the ATSC DTV signal as indicated in dashed-line form.

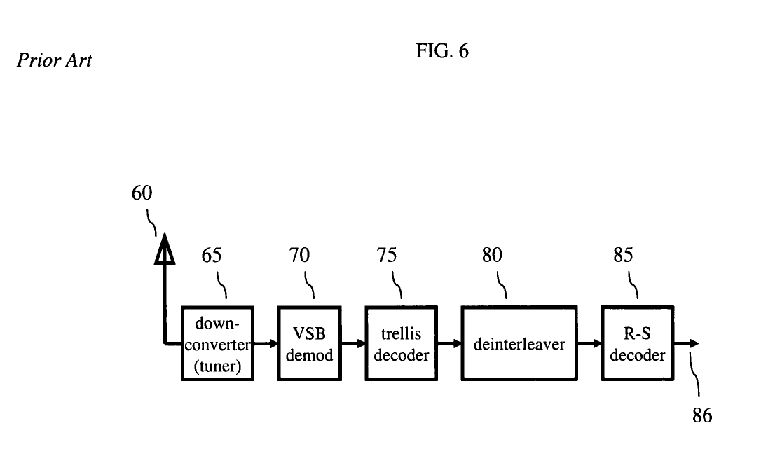

An existing ATSC receiver, shown in FIG. 6, carries out the inverse operation to recover the MPEG-2 transport stream (TS) stream from a received RF signal. Additionally, carrier recovery and timing recovery circuitry are required in the receiver to synchronize the local oscillator and sampling clock with those in the transmitters. To combat multiple paths introduced in the wireless channel, an equalizer is also required. Down-converter 65 includes a tuner for tuning to a channel to receive a broadcast signal via antenna 60 and provides a received signal to VSB domulator (demod) 70, which includes an equalizer (not shown). A demodulated signal is provided to trellis decoder 75 for trellis decoding. The resulting trellis decoded signal is applied to deinterleaver 80, which deinterleaves the trellis decoded signal in complementary fashion to that of interleaver 20 in the transmitter. The output signal from deinterleaver 80 is applied to Reed-Solomon (R-S) decoder 85, which provides a stream of packetized data 86.

As noted earlier, the ATSC DTV system was designed for fixed reception and performs poorly in a mobile environment. In this regard, there has been strong interest in developing an ATSC DTV system for mobile and handheld (M/H) devices while maintaining backward compatibility with the existing ATSC DTV system. As known in the art, in a legacy MPEG-2 transport stream, null packets are inserted when there are not enough data to transmit, i.e., as noted earlier, an ATSC DTV physical transmission channel has spare bandwidth. In terms of the null packets, a legacy ATSC receiver discards any received null packets. As such, in an ATSC DTV system for mobile and handheld (M/H) devices, the null packets can be used as a mobile data channel and still maintain backward compatibility with legacy ATSC DTV receivers. In particular, in the ATSC DTV Mobile/Handheld (M/H) system, mobile data, e.g., programs (e.g., TV shows), are transmitted using the spare bandwidth in an ATSC DTV PTC. This also enables “time-slicing”, so that the receiver of the handheld device only has to power up when receiving the mobile data—thus enabling the receiver to remain idle at other times and thereby reduce power consumption from the battery of the handheld device. It should also be noted that, instead of null packets, packets with a special packet identifier (PID) can be used to carry mobile data such that a legacy receiver will ignore packets with this special PID.

Unfortunately, the existing ATSC DTV system lacks the necessary signaling mechanism for time slicing. Therefore, and in accordance with the principles of the invention, a signal comprises a sequence of fields, each field having a synchronization portion and a data portion, a transmitter inserts a pseudonoise (PN) sequence into the synchronization portion of a field for use in identifying a presence of mobile data in the data portion of that field; and transmits the signal. In complementary fashion, a receiver receives the signal and upon detecting the PN sequence in the synchronization portion of the received signal determines whether or not mobile data is in the data portion of that field of the received signal.

Further, in an ATSC DTV signal, the field sync sequence is used as the training sequence for converging an equalizer of the receiver, where the equalizer compensates for channel distortion. However, in a mobile environment, the channel is more dynamic than in a fixed environment. As such, the equalizer in a mobile receiver needs to converge quickly to track the dynamic channel. Unfortunately, we have observed that the ATSC DTV field sync sequence occurs too infrequently for the equalizer of the receiver to quickly converge in a mobile environment. In particular, the field sync sequence occurs at a rate of one field-sync sequence per field (24.2 milli-seconds (ms)). While the data segment sync occurs more frequently, at a rate of one segment sync sequence per data segment (77.3 micro-seconds (μsec.)), the data segment sync consists of only 4 symbols. Therefore, and in accordance with the principles of the invention, mobile packets carry mobile data and additional mobile training information.

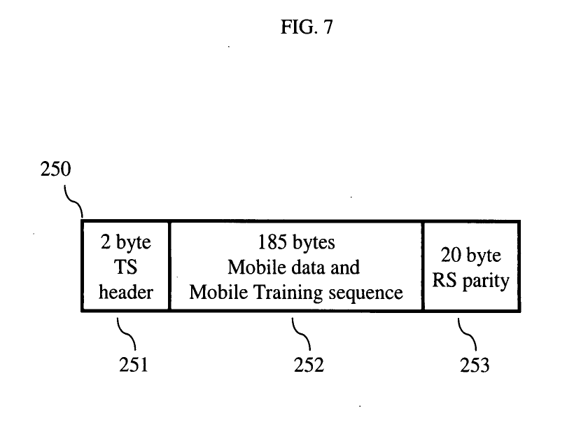

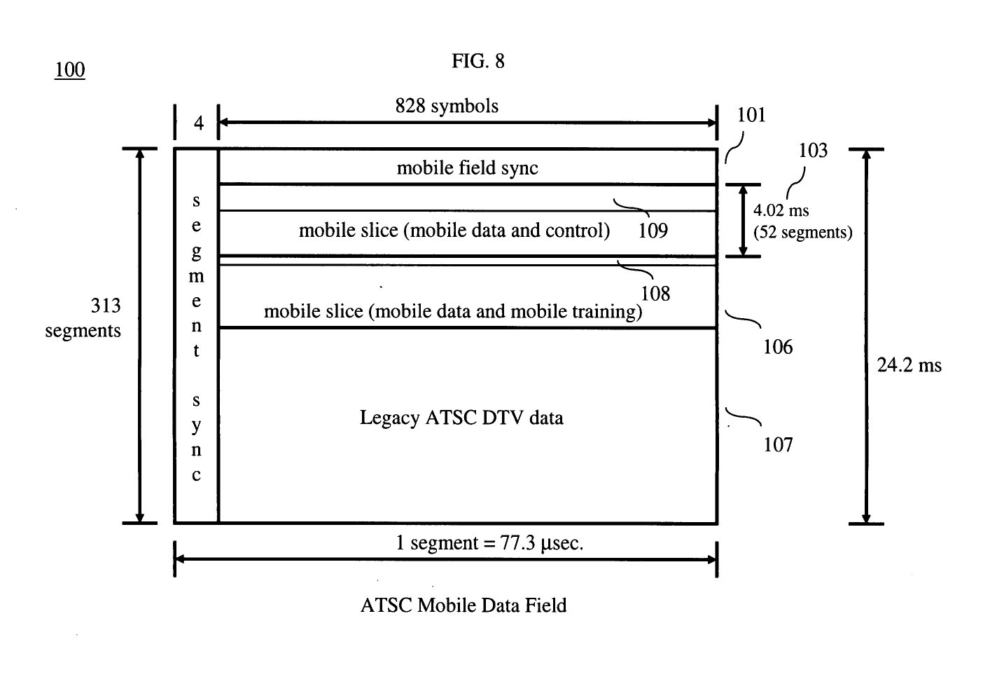

A mobile packet is an MPEG-2 transport packet having the structure shown in FIG. 7. Mobile packet 250 comprises a two byte header (251), 185 bytes conveying mobile data and a mobile training sequence (252) and 20 bytes of R-S parity information (253). To facilitate time slicing, mobile packets are transmitted in a data burst, which is referred to herein as a mobile burst. The basic unit of the mobile burst is 52 mobile packets, which is called a mobile slice. A mobile burst comprises N mobile slices (where N>1). The beginning of a mobile burst aligns with the beginning of a data field. A data field carrying mobile data is referred to herein as a mobile data field or mobile field. An illustrative mobile data field 100 is shown in FIG. 8. The ATSC data field of FIG. 5 has been modified to now include a mobile field sync 101 and a number of mobile slices, which are aligned at the beginning of a data field. As such a mobile data field comprises a mobile data portion and, if the mobile data portion does not take up the whole field, an ATSC legacy data portion. As can be observed from FIG. 8, there are two illustrative mobile slices in the mobile data portion of the mobile data field, i.e., N=2. The first mobile slice is mobile slice 103, which comprises 52 mobile packets (mobile data segments) and has a time duration of 4.02 ms. In the first mobile slice 103, control channel information (described further below) is contained in portion 109. Following mobile slice 103 is another mobile slice 106. It should be noted that in this example mobile training data appears in those mobile slices following the first mobile slice. This is illustrated by mobile training data portion 108 of the second mobile slice 106. As described further below, mobile training data appears in the same portion of a mobile slice facilitating quick identification by a receiver. If mobile data does not occupy the entire mobile field, then legacy ATSC data can be transmitted in the remaining portion of the mobile field (in the earlier described ATSC data segments). This is illustrated in FIG. 8 by the remaining part 107 of the mobile data field.

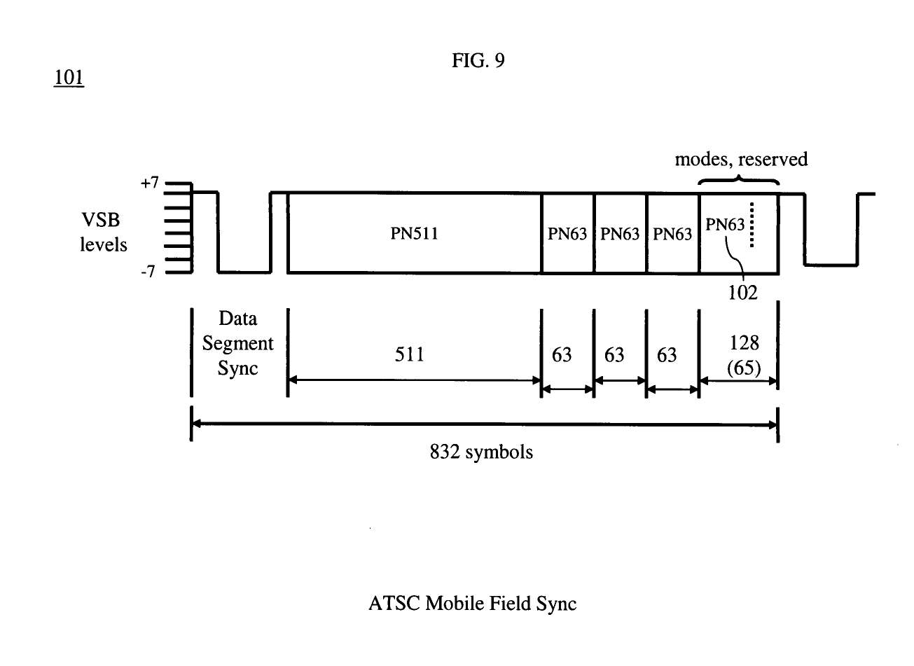

In accordance with the principles of the invention, mobile field sync 101 enables a receiver to quickly identify the presence of mobile data in an ATSC DTV M/H system. Referring now to FIG. 9, mobile field sync 101 comprises the aforementioned ATSC field sync modified with the insertion of a PN63 sequence 102 at the beginning of the reservation symbol field right after the VSB mode field. As such, a receiver can now quickly determine the presence of mobile data by the existence of a PN63 sequence in the reserved portion of a field sync segment. For example, the presence of a PN63 sequence in the reserved portion of the field sync segment represents the start of a mobile burst. Other variations are possible. For example, the sign of this PN sequence can be used as the indication of the start of a mobile burst, e.g., a positive sign. Thus, without further signaling, the mobile receiver can now quickly identify the presence of mobile data. Another example of physical layer signaling is embedding a counter in the reservation field to indicate that the mobile burst will appear after a number of data fields indicated by the counter, e.g., if the counter value equals 3, it means after 3 data fields at least one mobile slice will be present. If the counter value equals 0, it means the current data field contains at least one mobile slice. Since the receiver can now clearly identify mobile burst timing, the receiver may schedule to switch between a power-saving mode and a receiving mode to reduce power consumption. Identification and coordination of multiple mobile channels is achieved from the control channel information (described further below).

At this point, the following should also be noted with regard to the transmission of the mobile packets. The mobile data—other than the training data—is also forward error correction (FEC) encoded in FEC blocks. Illustratively, a low density parity check (LDPC) code is used. In particular, the short block length code as defined in ETSI EN 302 307, v.1.1.2, Digital Video Broadcasting (DVB); Second generation framing structure, channel coding and modulation systems for Broadcasting, Interactive Services, News Gathering and other broadband satellite applications is used. This short block length is 16,200 bits long, or 2025 bytes. In terms of mobile packets, which have a payload of 185 bytes, there are 11 mobile packets in each FEC block and an integral number of FEC blocks in each mobile burst.

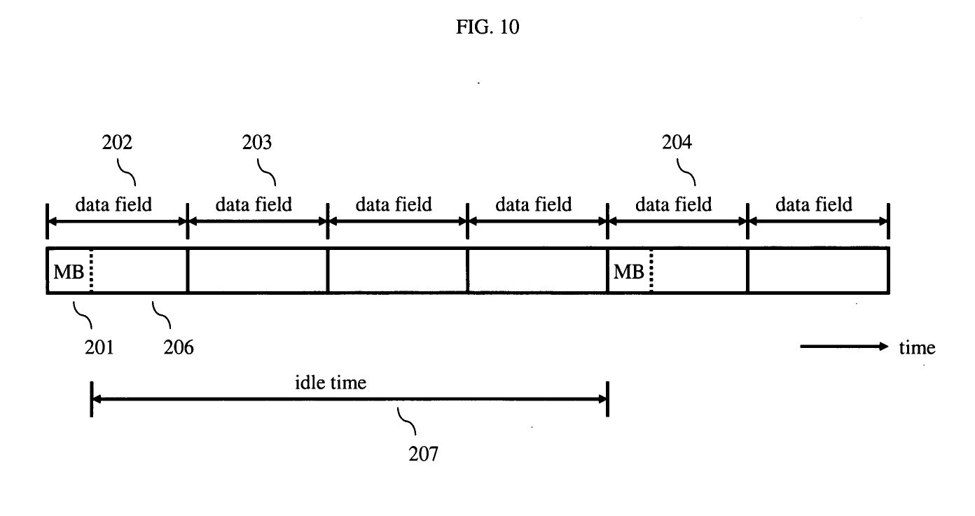

Referring now to FIG. 10, in an ATSC DTV mobile system mobile bursts are transmitted every M data fields, where M can be configured in the system and should be large enough to reduce the power consumption of the mobile/handheld device by using time-slicing. For purpose of illustration, let N=2, and M=4. As such, there are two mobile slices in each mobile burst, and there is one mobile burst every fourth data field. This is illustrated in FIG. 10, which shows a sequence of transmitted data fields. Data field 202 is a mobile data field and conveys mobile burst (MB) 201. As such, data field 202 has the structure shown in FIG. 8. Data field 203 is a legacy data field. As can be observed from FIG. 10, the next mobile burst occurs in data field 204. Continuing with this example, the time duration of four fields is (24.2 ms)(4)=96.8 ms. As such, the amount of time required for a receiver of a mobile device to be powered-up is at least ((24.2)(2)(52))/313≅8.04 ms. This results in a duty cycle in the mobile device of 8.04/96.8˜=8.30%. The duty cycle time may increase due to other receiver processing, e.g., if one assumes that one mobile slice time is required to clear the deinterleaver of the receiver, then the amount of time required for a receiver of a mobile device to be powered-up is ((24.2)(3)(52))/313≅12.06 ms, with a resulting duty cycle of 12.06/96.8˜=12.46%. In this example, the raw data rate for mobile data and training is 52*2*207*8 bit/96.8 ms=1.78 Mbit/s. Thus, in this example a receiver can be powered-down for the three data fields following data field 202 and for that portion 206 of data field 202. This time during which the receiver is powered down is also referred to as idle time and is illustratively shown in FIG. 10 as idle time 207.

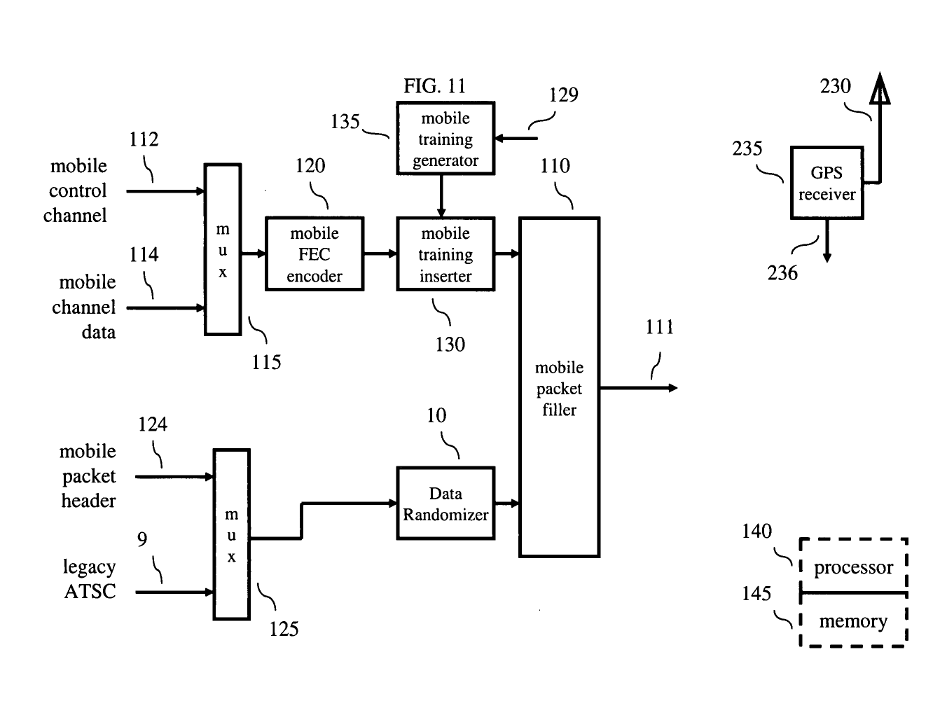

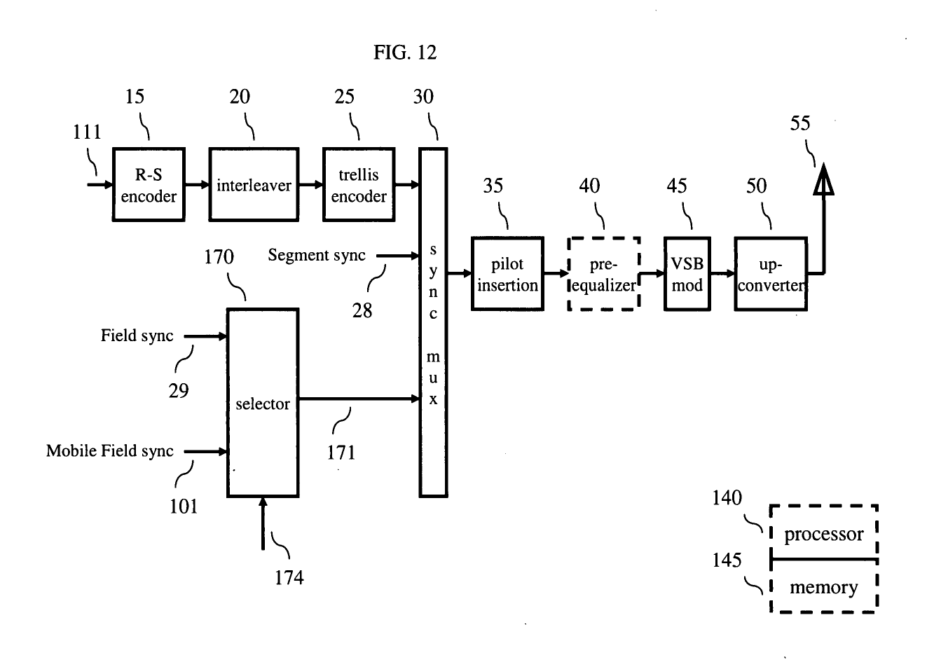

Turning now to FIGS. 11 and 12, an illustrative embodiment of an ATSC DTV mobile transmitter is shown in accordance with the principles of the invention. Only those portions relevant to the inventive concept are shown. The ASTC DTV mobile transmitter is a processor-based system and includes one, or more, processors and associated memory as represented by processor 140 and memory 145 shown in the form of dashed boxes in FIG. 11. In this context, computer programs, or software, are stored in memory 145 for execution by processor 140 and, e.g., implement mobile FEC encoder 120. Processor 140 is representative of one, or more, stored-program control processors and these do not have to be dedicated to the transmitter function, e.g., processor 140 may also control other functions of the ATSC DTV mobile transmitter. Memory 145 is representative of any storage device, e.g., random-access memory (RAM), read-only memory (ROM), etc.; may be internal and/or external to the transmitter; and is volatile and/or non-volatile as necessary.

The elements shown in FIG. 11 comprise a multiplexer (mux) 115, mobile forward error correction (FEC) encoder 120, mux 125, mobile training inserter 130, mobile training generator 135, data randomizer 10, mobile packet filler 110, Global Position System (GPS) receiver 235 and GPS antenna 230. GPS receiver 235 receives a GPS signal from GPS antenna 230 for providing time synchronization information for use in the transmitter in transmitting the ATSC DTV mobile signal. Mux 125 provides packets, which are either legacy ATSC packets or empty mobile packets with just the mobile packet headers. These empty mobile packets are null packets now being used to convey mobile data. The null packets are in compliance with the MPEG-2 defined format. With the help of the above-described mobile field sync signaling, an ATSC DTV mobile receiver can identify mobile packets. This packet data—either the legacy ATSC packets as described earlier with respect to FIG. 1—or just the headers of the mobile packets, are randomized by data randomizer 10. The resulting data stream is applied to mobile packet filler 110. Mux 115 provides the mobile data that is conveyed in a mobile packet. As shown in FIG. 11, this mobile data comprises mobile control channel information (described below), or mobile channel data itself (e.g., program data such as video, audio, etc.). The mobile data is provided to mobile FEC encoder 120, which provides additional error protection given the dynamics of the mobile channel and provides FEC encoded mobile data to mobile training inserter 130.

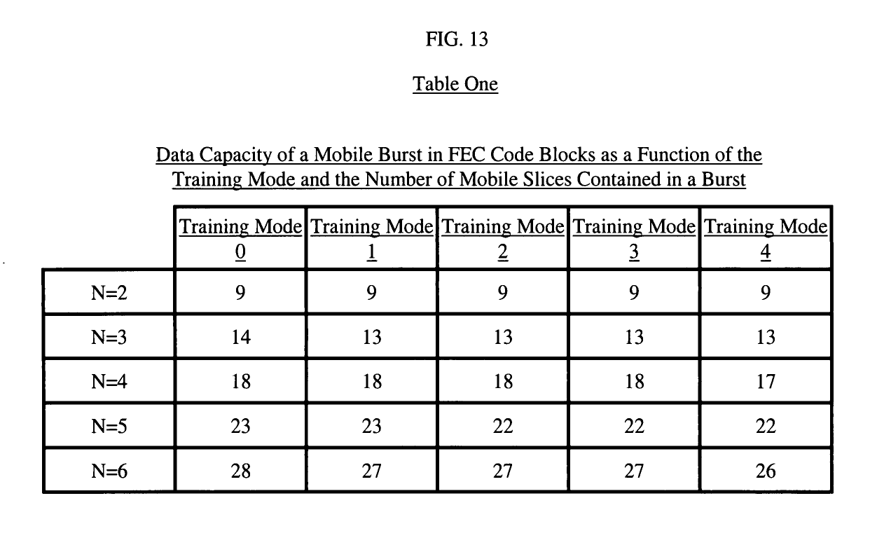

As noted earlier, FEC encoder 120 uses an LDPC code and short block lengths as defined in ETSI EN 302 307, v.1.1.2. FEC encoder 120 breaks the data up into FEC blocks, where there are 11 mobile packets in each FEC block. There are 11 possible code rates, i.e., ¼, ⅓, ⅖, ½, ⅗, ⅔, ¾, ⅘, ⅚, 8/9. For example, a rate ¼FEC block will contain 506 bytes of mobile data, while a rate ½ FEC block will contain 1012 bytes of mobile data. Table One of FIG. 13 shows the number of FEC code blocks contained in N mobile slices for values of N from two to six for the five different training modes (described further below). For example, for N=2, nine FEC blocks are conveyed in the two mobile slices of the mobile data field.

In terms of the FEC encoding, the following should additionally be noted with respect to puncturing or repeating the coded bits of LDPC codes blocks. For N mobile slices, the number of mobile packets used for mobile information is denoted as Nₘ, the number of the LDPC code block is denoted as N_{ldpc}, and the training mode is denoted as T_{mode}. In addition, the following functions are defined: f(T_{mode})=1 if T_{mode}>0 and f(T_{mode})=0 if T_{mode}=0. With this in mind, the following are the rules for puncturing or repeating the coded bits of LDPC codes blocks:
1. Compute x=Nₘ*185*8−[T_{mode}*207*8+f(T_{mode})*48]*(N−1)−N_{ldpc}*16200 (bits).
2. If x>0, the LDPC coded bits are repeated. The x bits are evenly distributed among the N_{ldpc} code blocks. Let y=floor(x/N_{ldpc}), and M=x−y*N_{ldpc}. For each of the first M code blocks, the number of the repeated bits is (y+1). For each of the rest of the (N_{ldpc}−M) code blocks, the number of repeated bits is y bits.
3. Denote an LDPC code block as [C₀, C₁, . . . , C₁₆₁₉₉]. If the number of repeated bits for this code block is w, the code block will be [C₀, C₁, . . . , C₁₆₁₉₉, C₀, C₁, C_{w-1}] after repetition.
4. If x<0, the LDPC coded bits are punctured. The |x| bits are even punctured among the N_{ldpc} code blocks. Let y=floor(|x|/N_{ldpc}), and M=|x|−y*N_{ldpc}. For each of the first M code blocks, the number of the punctured bits is (y+1). For each of the rest of the (N_{ldpc}−M) code blocks, the number of punctured bits is y.
5. Denote an LDPC code block as [C₀, C₁, . . . , C₁₆₁₉₉]. If the number of punctured bits for this code block is w, the code block will be [C₀, C₁, . . . , C_{16199-w}] after puncturing.

As described below, it should be noted that for T_{mode}>0 there are training sequences that are contiguous after the convolutional interleaving. In order to generate known training symbols at the output of the trellis encoder, the trellis encoder needs to be reset to a known state at the beginning of each contiguous training sequence. For this purpose, 48 bits are used to reset the 12 trellis encoder to a known state, which explains the 48 bits used in the computation of the number x above in rule 1. The trellis reset operation also requires the re-calculation of the parity bits for those packets that contain the trellis reset bits.

Mobile training inserter 130 inserts mobile training data into the data stream. The mobile training data inserted is provided by mobile training generator 135, which is controlled by signal 129, which sets the training mode (described below). The resultant data stream—mobile channel data, mobile control channel, mobile training data—is applied to mobile packet filler 110. The latter simply passes the legacy ATSC data, but when an empty mobile packet is received, fills the empty mobile packets with the mobile data. The resulting data stream of ATSC legacy packets and mobile packets are provided via signal 111.

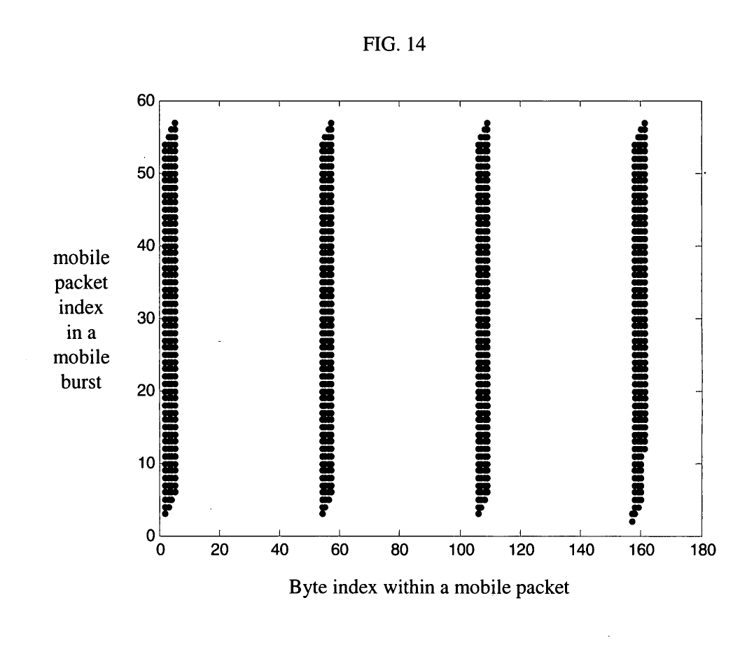

As noted above, mobile packets do not just convey mobile channel data such as video and audio components of a program. Mobile packets also convey mobile training data to improve equalizer response in the receiver in a mobile communications environment. However, it is not just a matter of adding more training information. We have observed that it is preferable to have all the training data be accessible as quickly as possible to a receiver. Thus, the receiver should not have to collect training data dispersed in separate locations within the mobile packet or across a number of widely separated mobile packets. Therefore, and in accordance with the principles of the invention, mobile data inserted by mobile training inserter 130 is inserted in such a way to take into account the effect of interleaver 20 (described earlier in FIG. 1) of the transmitter. In other words, mobile training data is inserted in positions in a mobile packet such that after interleaving the mobile training data appears in contiguous positions. For example, let N=2. The training data is inserted to appear in the (52)(2)=104 mobile packets as shown in FIG. 14 before the interleaving operation, where the horizontal axis represents the byte index within a mobile packet, and the vertical axis represents the index of a mobile packet within a mobile burst. It should be noted that both indices start from 0. One black dot represents a training byte. As a result of inserting the mobile training data into mobile packets as shown in FIG. 14, the interleaving operation performed by interleaver 20 causes these training bytes to appear in contiguous packets with packet indices: 54, 55, 56 and 57 within a mobile burst.

In particular, and in accordance with the principles of the invention, the mobile training bytes are inserted in the mobile packets such that after interleaving these training bytes appear in packets with a packet index in the mobile burst that is in the following five possible index sets (or modes):

Mode 0—empty set, i.e., no training data

Mode 1—{y|x+52n, xε{54}, n=0, 1, . . . , N−2}

Mode 2—{y|x+52n, xε{54,55}, n=0, 1, . . . , N−2}

Mode 3—{y|x+52n, xε{54,55,56}, n=0, 1, . . . , N−2}

Mode 4—{y|x+52n, xε{54,55,56,57}, n=0, 1, . . . , N−2}.

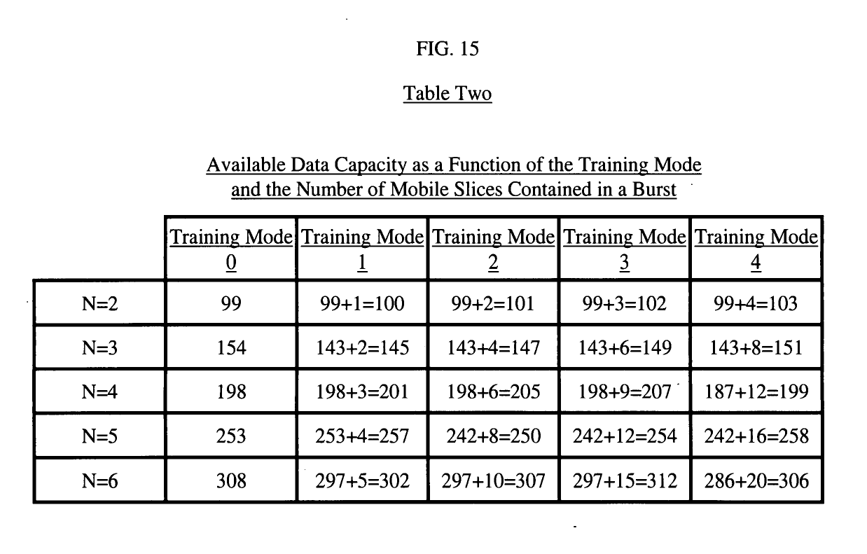

The mode is set via signal 129 by processor 140. For example, in mode 4, which is illustrated in FIG. 14, for N=2, mobile packets 54, 55, 56 and 57 convey the mobile training data (i.e., this is four mobile data segments of a mobile data field and is represented by portion 108 of FIG. 8). Thus, a corresponding receiver can quickly locate and use the mobile training data. Since the mobile training data takes up space in a mobile burst, Table Two of FIG. 15 illustrates the number of packets available for mobile data in the different training modes for values of N from two to six. It should be observed from Table Two that there might be some unused packets in a mobile burst because of the FEC blocking (described above). In particular, an integral number of FEC blocks occur in a mobile burst and there are 11 mobile packets in an FEC block. As such, consider N=2 and training mode 4. Table Two shows that 99 packets are available for conveying data, not 100 packets as might be expected. This is because of the FEC blocking, i.e., 99 packets represents 9 FEC blocks, each FEC block conveying 11 packets. FIG. 14 illustrates training mode 4, which conveys the most training data. The remaining training modes are straightforward modifications of the patterns shown in FIG. 14 since they all use subsets of the training bytes shown in FIG. 14.

In mobile training generator 135, the mobile training bytes are generated using a linear feedback shifted register (LFSR) with generator polynomial G(x)=x¹³+x⁴+x³+x¹+1, and initial condition 0x1FFF. The output bits of the shift register are grouped into bytes where the first bit is the MSB (most significant bit). As mentioned earlier, in order to generate known training symbols at the output of the trellis encoder, trellis encoder 25 of FIG. 12 needs to be reset to a known state at the beginning of each contiguous training sequence. For this purpose, 48 bits are used to reset the 12 trellis encoder to a known state.

Referring now to FIG. 12 to continue the description of the ATSC DTV mobile transmitter, the elements shown in FIG. 12 comprise a R-S encoder 15, interleaver 20, trellis encoder 25, sync mux 30, pilot insertion 35, pre-equalizer 40, VSB mod 45, upconverter 50 and antenna 55, which all function as described earlier. Additionally, selector element 170 is present. Selector element 170, under the control of signal 174 (e.g., via processor 140) selects between either an ATSC field sync 29 (if only legacy ATSC data is being transmitted) or the mobile field sync 101 (if a mobile field is being transmitted as described above with respect to FIGS. 7, 8, 9 and 10). The selected field sync 171 is provided to sync mux 30 for use in forming the data field. Processor 140 controls the operation of the transmitter in accordance with the value for N, the number of mobile slices in a mobile burst, and the value for M, which is the frequency of occurrence of mobile bursts, i.e., in every M data fields.

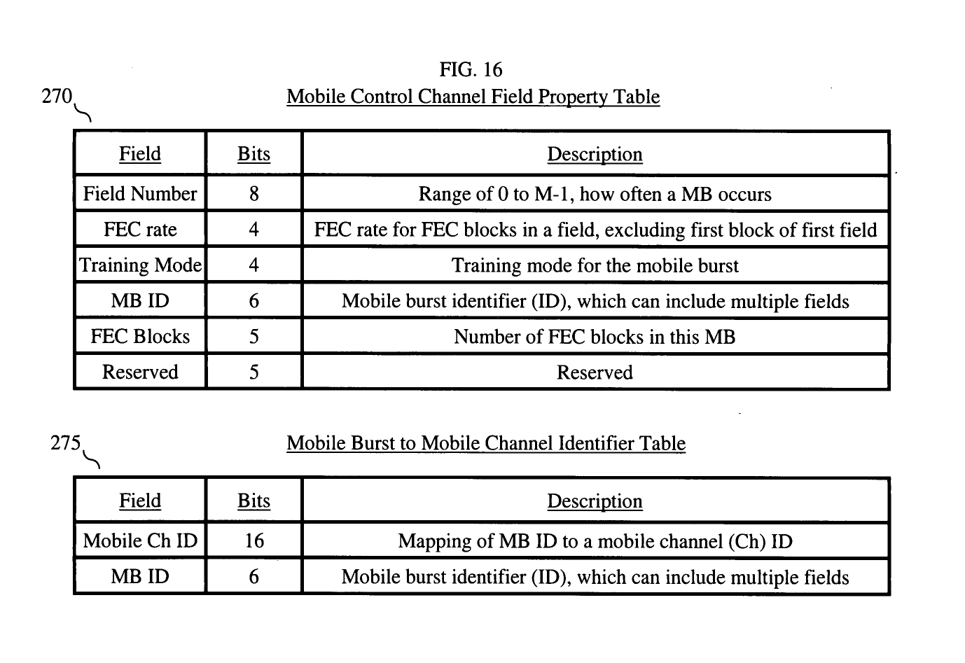

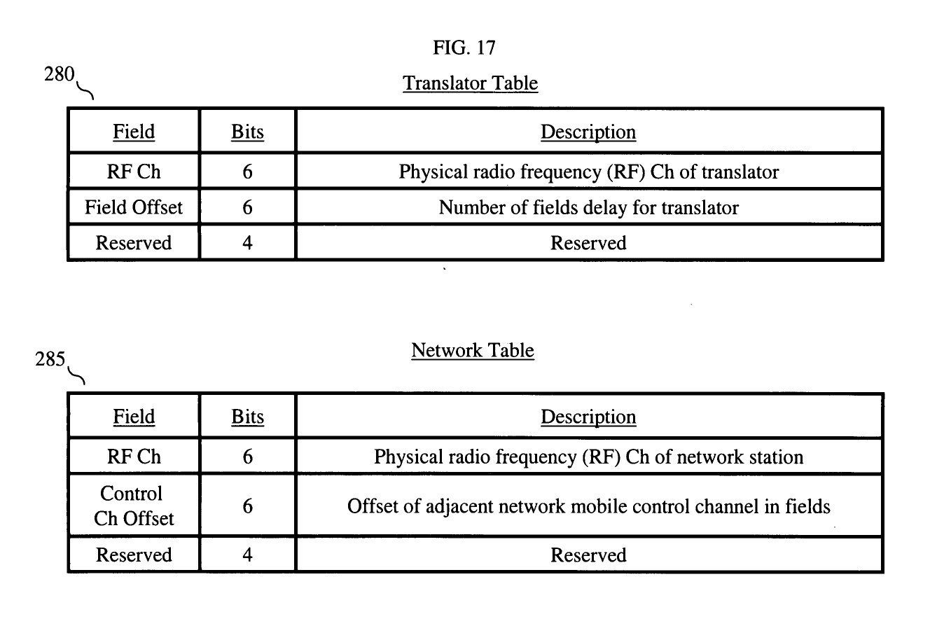

As noted above, mobile control channel information is transmitted in the first mobile slice of a mobile burst for use by a receiver. The portion of the mobile slice conveying the mobile control channel information is referred to herein as the mobile control channel and is the first FEC block in the first mobile slice of a mobile burst. The first mobile slice, and therefore the presence of the mobile control channel, is identified by the presence of the mobile field sync segment, described earlier. The first FEC block is coded at a coding rate of ¼. It should be noted that the mobile control channel does not need to be the first FEC block, it simply needs to be transmitted in a known time with known FEC and training characteristics. The mobile control channel information comprises a number of tables as shown in FIGS. 16 and 17.

Table 270 of FIG. 16 is the Mobile Control Channel Field Property Table and comprises six fields: a “Field Number” field, an “FEC rate” field, a “Training Mode” field, an “MB ID” field, an “FEC blocks” field and a “Reserved” field. The “Field Number” field is 8 bits long and has a value from 0 to M−1, where M is an integer. The “Field Number” field defines how often a mobile burst occurs, i.e., one mobile burst every M fields. As such, a receiver will be able to quickly determine how often a mobile burst occurs for the purpose of determining an idle time for the receiver for use in determining a power-down mode of operation (e.g., see the idle time calculation with respect to FIG. 10). The “FEC rate” field is 4 bits long and tells the receiver the coding rate used for the FEC blocks in the mobile burst (except for the first FEC block as noted above, which is coded at a coding rate of ¼). The “Training Mode” field is 4 bits long and specifies for the receiver the training mode of the mobile burst. The “MB ID” field is 6 bits long and provides an identification (ID) number for this specific mobile burst, which can include multiple mobile fields. This enables the receiver to identify particular mobile bursts. The “FEC blocks” field is 5 bits long and tells the receiver how many FEC blocks are in the mobile burst. As a result, the receiver can determine how many data fields comprise the mobile burst. The “Reserved” field is 5 bits long and reserved for future use. This data block of six fields is terminated with a 0xFFFFFFFF entry.

Table 275 of FIG. 16 is the Mobile Burst to Mobile Channel Identifier Table and comprises two fields: a “Mobile Ch ID” field and an “MB ID” field. The “Mobile Ch ID” field is 16 bits long and identifies a mobile channel number. The “MB ID” field is 6 bits long and identifies a specific mobile burst, which can include multiple mobile fields. As such, the two fields together map a mobile burst to a mobile channel. This table can comprise a list of entries (or pairings) providing information on mobile channels and associated mobile bursts to the receiver. A mobile channel identifier and MB ID pair of 0xFFFFFF indicates the end of the list. The parameters are padded to the nearest byte boundary.

Table 280 of FIG. 17 is the Translator Table and comprises three fields: a “Physical RF Ch” field, a “Field Offset” field, and a “Reserved” field. The “Physical RF Ch” field is 6 bits long and is the radio frequency (RF) channel of a translator (associated station) (described further below). The “Field Offset” field is 6 bits long and is the number of fields the associated station is delayed in transmission from the current channel. The “Reserved” field is 4 bits long and reserved for future use. This table can comprise a list of entries providing information on same network translators available to the receiver. A 0xFF value terminates the list.

Table 285 of FIG. 17 is the Network Table and comprises three fields: a “Physical RF Ch” field, a “Control Ch Offset” field, and a “Reserved” field. The “Physical RF Ch” field is 6 bits long and is the radio frequency (RF) channel of a an adjacent network station (associated station) (described further below). The “Control Ch Offset” field is 6 bits long and is the number of fields the mobile control channel of the associated station is delayed in transmission from the current channel. The “Control Ch Offset” field is variable and enables hopping between adjacent network channels carrying identical programming. The “Reserved” field is 4 bits long and reserved for future use. This table can comprise a list of entries for providing information an adjacent same network coverage areas for the currently received channel. Thus, operators can have offsets in control channels and programming to enable hopping between coverage areas in fringe areas. A 0xFF value terminates the list.

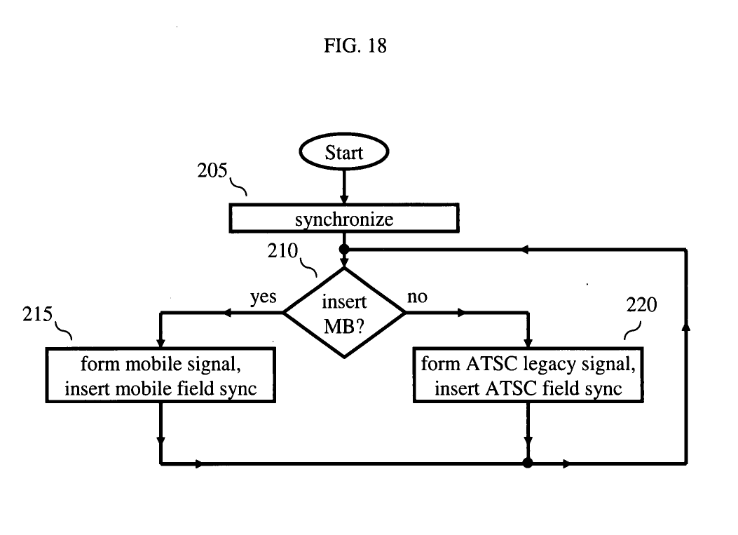

Turning now to FIG. 18, an illustrative flow chart for use in an ATSC DTV mobile transmitter is shown. In step 205, processor 140 synchronizes the transmission using the GPS information 236 from GPS receiver 235. In particular, synchronization is easily achieved by the use of GPS timing, where the 1 pulse per second GPS pulse is used as a reference for mobile data framing at the transmitter. As a result, the ATSC DTV mobile transmitter can transmit synchronously with respect to other associated stations, e.g., a translator re-broadcasting the same program to provide better coverage in an area previously prone to poor mobile reception or with respect to a network station in an adjacent coverage area. In step 210, processor 140 determines if a mobile burst is scheduled for transmitted in accordance with the value of M. If a mobile burst is scheduled for transmission, then in step 215 processor 140 controls the forming of a mobile burst as described above to provide one or more mobile data field(s), where a mobile field sync is inserted in the first mobile data field (e.g., via signal 174 and selector 170 of FIG. 12) for identification of the first mobile field of the mobile burst. As described above, this mobile field sync can be implemented in any one of a number of ways. For example, a particular sign of a PN63 sequence, a counter, etc. It should be noted that, in accordance with the principles of the invention, if the mobile burst comprises more than one mobile field, processor 140 can insert a modified mobile field sync in step 215 for those other mobile fields to indicate that the mobile field is a part of a mobile burst and does not have mobile control information conveyed therein. However, if a mobile burst is not scheduled, then processor 140 controls the forming of an ATSC signal, including the insertion of an ATSC field sync in step 220 (e.g., via signal 174 and selector 170 of FIG. 12). It should also be noted that, in accordance with the principles of the invention, processor 140 could insert a modified ATSC field sync in step 220, where data is still inserted into the reserved field to indicate that only legacy data is carried in the current data field.

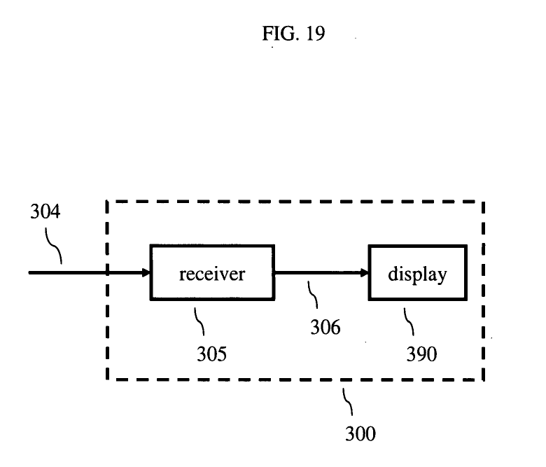

Referring now to FIG. 19, an illustrative embodiment of a device 300 in accordance with the principles of the invention is shown. Device 300 is representative of any processor-based platform, whether hand-held, mobile or stationary. For example, a PC, a server, a set-top box, a personal digital assistant (PDA), a cellular telephone, a mobile digital television (DTV), a DTV, etc. In this regard, device 300 includes one, or more, processors with associated memory (not shown). Device 300 includes a receiver 305 and a display 390. Receiver 305 receives a broadcast signal 304 (e.g., via an antenna (not shown)) for processing to recover therefrom, e.g., a video signal for application to display 390 for viewing video content thereon.

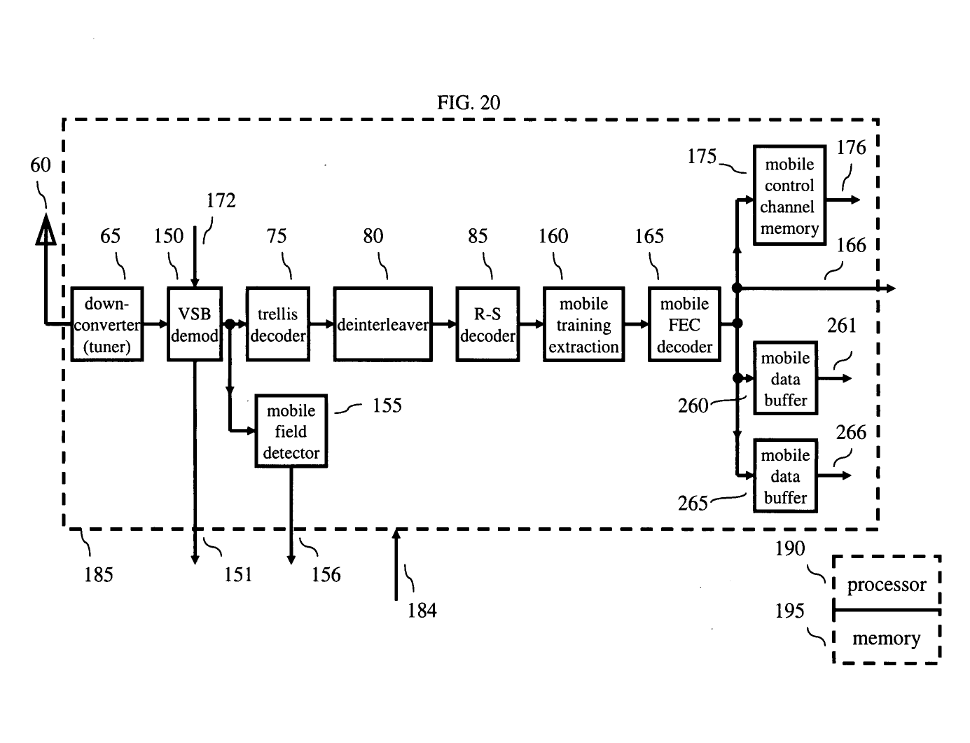

Turning now to receiver 305, an illustrative portion of receiver 305 in accordance with the principles of the invention is shown in FIG. 20. Only those portions relevant to the inventive concept are shown. Receiver 305 is a processor-based system and includes one, or more, processors and associated memory as represented by processor 190 and memory 195 shown in the form of dashed boxes in FIG. 20. In this context, computer programs, or software, are stored in memory 195 for execution by processor 190 and, e.g., implement mobile field detector 155. Processor 190 is representative of one, or more, stored-program control processors and these do not have to be dedicated to the receiver function, e.g., processor 190 may also control other functions of receiver 305. Memory 195 is representative of any storage device, e.g., random-access memory (RAM), read-only memory (ROM), etc.; may be internal and/or external to receiver 305; and is volatile and/or non-volatile as necessary.

Receiver 305 includes antenna 60 and receiver portion 185. The latter comprises down-converter 65, trellis decoder 75, deinterleaver 80, R-S decoder 85. These elements, other than as described below, function as described earlier with respect to FIG. 6. In accordance with the principles of the invention, receiver portion 185 also comprises VSB demod 150, mobile field detector 155, mobile training extraction element 160, mobile FEC decoder 165, mobile control channel memory 175, mobile data buffer 260 and mobile data buffer 265. It should be noted that the signaling paths represented in the figures are representative of, e.g., address bus, data bus and control bus signaling, which are not shown in detail for simplicity. Power consumption of receiver portion 185 is controlled via signal 184, e.g., from processor 190. For example, receiver portion 185 may be powered-down during those times when no mobile data is being received. Assuming for the moment that receiver portion 185 is powered-up, down-converter 65 is tuned to a channel conveying both ATSC legacy programming and mobile programming and provides a received signal to VSB demod 150. VSB demod 150 is similar to VSB demod 70 of FIG. 6 except that VSB demod 150 uses the mobile training data for tracking changes in the communications channel. VSB demod 150 demodulates the received signal and provides a demodulated signal to trellis decoder 75 and mobile field detector 155. The latter searches for the above-described mobile field sync, e.g., correlates the received field sync segment with the known value of the mobile field sync segment. Upon detection of the mobile field sync—which indicates the presence of mobile data in a received mobile data field—mobile field sync detector provides a mobile burst detected signal 156 for use by, e.g., processor 190 for controlling operation of device 300. Trellis decoder 75 decodes the demodulated data and provides trellis decoded data to deinterleaver 80, which deinterleaves the resulting data stream in a complementary fashion to interleaver 20 of the transmitter described earlier (see FIG. 2). The deinterleaved data is applied to R-S decoder 85 for Reed Solomon decoding. The resulting output signal is applied to mobile training extraction element 160, which removes the previously inserted training data from the data stream. The resulting data stream is provided to mobile FEC decoder 165, which LDPC decodes the resulting data stream to provide output data 166. This output data can be stored, e.g., in mobile data buffer 260 and/or 265. This mobile data includes program data for the selected channel, e.g., audio and video for the current program and program guide information for the current channel, e.g., formatted in a similar manner to that defined in accordance with the “ATSC Standard: Program and System Information Protocol for Terrestrial Broadcast and Cable” Doc A/65.

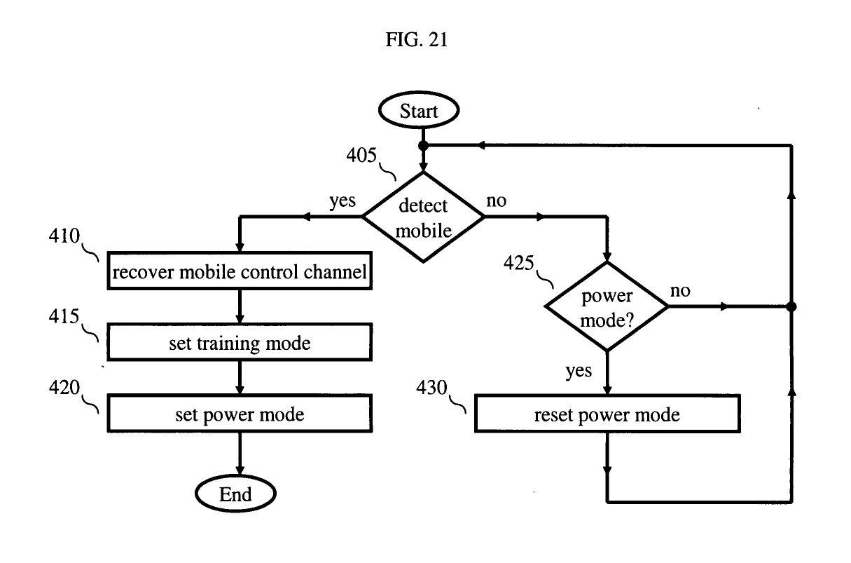

Referring now to FIG. 21, an illustrative flow chart for use in device 300 is shown. In step 405, device 300 (e.g., processor 190) looks to acquire a mobile signal by searching for the mobile sync field. This is step is performed when first tuning to a channel, or if there is a loss of synchronization, or upon power-up (in accordance with a set power mode). As used herein, the term “power mode” refers to performing a power management function where, e.g., portions of device 300 are powered-down to conserved power usage. If the mobile sync field is not detected, device 300 checks if a power mode was set in step 425. If a power mode had been previously set, there is a loss of synchronization and device 300 resets the power mode in step 430, e.g., receiver portion 185 of FIG. 20 is now kept powered-up. In any event, device 300 continues to search for a mobile field in step 405. However, upon detection of the mobile sync field (e.g., via mobile field detector 155) in step 405, device 300 recovers the mobile control channel for storage in mobile control channel memory 175 in step 410. As described above, in this example, the mobile control channel is in the first FEC block of the mobile burst. From the mobile control channel information stored in memory 175 (via signal 176), device 300 determines the training mode in step 415 and provides this to VSB demod 150, via signal 172. Thus, VSB demod 150 is set to the number of mobile packets conveying mobile training data and their location in the mobile field for use in converging the equalizer (not shown). In addition, in step 420, device 300 sets the power mode by determining the values for N and M, i.e., how many mobile slices are in a mobile burst (this is derived from the “FEC Blocks” field value stored in memory 175) and how often the mobile bursts occur in the ATSC DTV mobile signal (this is derived from the “Field Number” field value stored in memory 175). As a result, device 300 can enter a power-saving mode, or update a previously set power mode, such that receiver portion 185 is powered down during those periods of time when no mobile burst is expected to be received as described earlier with respect to FIG. 10. This power saving mode exists until the channel is changed or there is a loss of synchronization or a user of the device intervenes, etc.

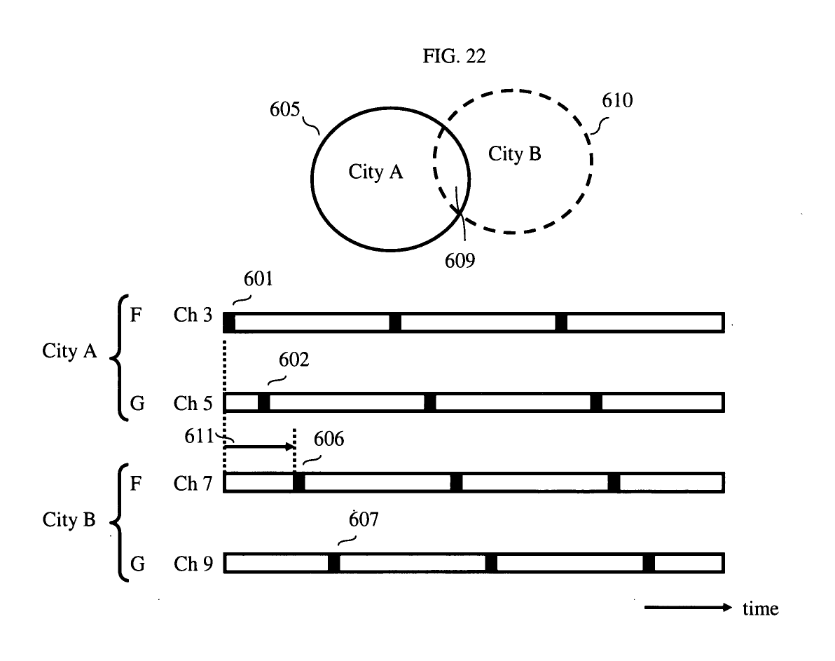

As noted earlier, an ATSC DTV mobile transmitter can utilize a GPS receiver for synchronizing transmissions with other associated stations. Indeed, by insuring orthogonal time and/or frequency relationships between mobile/handheld broadcasts, additional coverage benefits can be obtained. One example is shown in FIG. 22, where a network F has an associated ATSC DTV mobile transmitter transmitting on channel 3 (associated with an RF channel) having a coverage area 605 generally associated with a city A. In addition, network F also has an associated ATSC DTV mobile transmitter transmitting on channel 7 (associated with an RF channel) for providing the same programming to a coverage area 610 generally associated with an adjacent city B. Similarly, a network G provides programming on channel 5 for city A and the same programming on channel 9 for city B. As shown in FIG. 22, coverage area 605 and coverage area 610 overlap—this result in overlapping coverage area 609. In overlapping coverage area 609 it is possible for a mobile receiver to receive broadcasts from both channels 3 and 7 for network A at the same time by synchronizing the transmissions.

As such, and in accordance with the principles of the invention, in adjacent coverage areas each transmitter offsets the time of a mobile data broadcast, giving the mobile receiver an opportunity to grab data/programming from both coverage areas in an overlapping coverage area. This is illustrated in FIG. 22, where mobile bursts from the transmitter for Ch 7 are offset by time delay 611. This is illustrated by mobile burst 606, which occurs after a fixed time delay 611 from mobile burst 601 from the transmitter for Ch 3. Similar illustrative delays are shown for the adjacent coverage areas for network G (e.g., mobile burst 607 for Ch 9 is delayed with respect to mobile burst 602 for Ch 5.

Thus, when a mobile receiver is receiving programming from, e.g., network A in coverage area 605, it is possible in effect for network A to handoff the mobile receiver to the transmitter serving coverage area 610 when the mobile receiver moves from coverage area 605 to coverage area 610 through overlapping coverage area 609. Similarly, the transmitter serving coverage area 610 can handoff the mobile receiver to the transmitter serving coverage area 605 when the mobile receiver moves from coverage area 610 to coverage area 605 through overlapping coverage area 609.

A key benefit to this approach is that the mobile receiver needs only one demodulator. The mobile receiver jumps, or hops, between RF channels within the “idle time” of the main program. This jumping only takes place when necessary, e.g., when a signal from the same network is found from an adjacent coverage area. This allows the user to continue receiving network programming from one coverage area that is next to an adjacent coverage area. Buffers in the mobile receiver capture data/programming from both coverage areas, and error free packets are selected to be decoded for use (e.g., mobile data buffers 260 and 265 of FIG. 20). This concept of handoff is new to broadcast television, since a stationary audience was assumed, although it has been addressed in cellular networks. The time and/or frequency separation enables a single receiver (demodulator) to support handoff between two broadcast coverage areas. This remains a very efficient use of spectrum, since the mobile bursts are shared with traditional High Definition TV content as described above, e.g., see FIG. 10.

This offset in transmission time between adjacent coverage areas is set a priori by network administrators and is provided in Network Table 285 of FIG. 17 in the mobile control channel information to all mobile receivers. Thus for the current received channel, the mobile receiver can determine a list of adjacent coverage areas for the same programming. Illustratively, one way to check for an adjacent coverage area is when the signal currently being demodulated becomes degraded, e.g., an associated received signal strength indicator (RSSI) is below a predetermined value. It should be observed from Network Table 285 that the offset is to the next mobile burst conveying the mobile control channel for the associated station so that the mobile receiver can receive network information for mobile transmission in the adjacent coverage area.

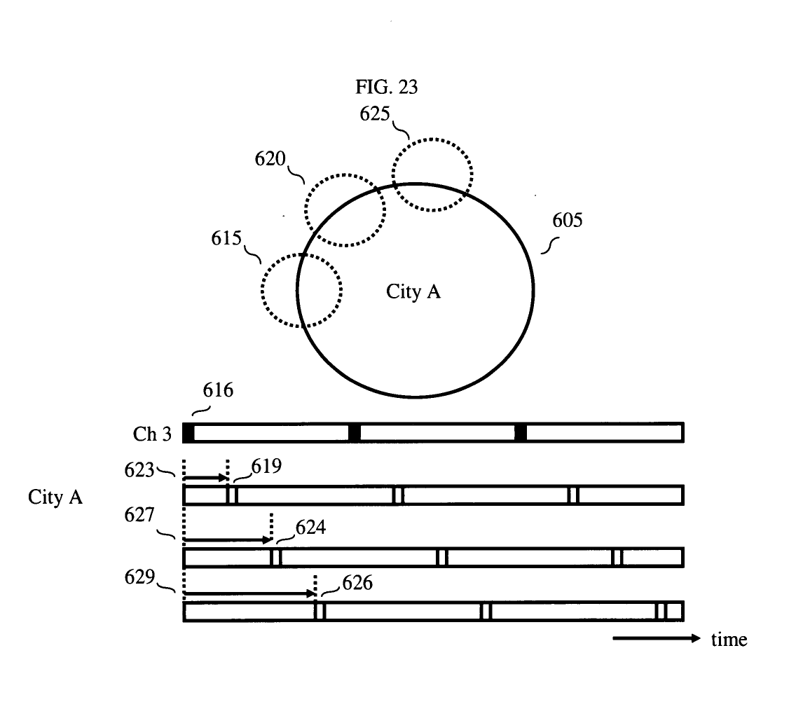

This concept can be extended to improving coverage in the same coverage area using translator stations. In particular, coverage is improved by allowing a time division mobile receiver opportunities to receive the same material in a different time slot on a different channel. When the receiver can see both translator and main channel intermittently, the receiver can try to lock to both to get continuous signal reception. Because of the time division nature of the signal, the receiver can achieve this if the translator and main channel stations are synchronized and separated by a time interval. The translator station repeats program material in another frequency channel to improve coverage in a region of the service area, or in order to extend the service area. As a result, during periods of poor reception, a mobile receiver can check for a translator station by looking it up in Translator Table 280 of FIG. 17 and hopping between the main and translator stations, without disturbing reception of the main signal. This is illustrated in FIG. 23 for coverage area 605, which now has translator stations (or transmitters), which repeat the programming on a different frequency and offset in time from the main channel. As can be observed from FIG. 23, channel 3 has a main transmitter that transmits a mobile burst 616. There are also three translator stations having coverage areas 615, 620 and 625. Translator 615 transmits a mobile burst 619 delayed by time interval 623; translator 620 transmits a mobile burst 624 delayed by time interval 627; and translator 625 transmits a mobile burst 626 delayed by time interval 629. If the mobile receiver detects an area of poor reception, the mobile receiver checks to determine if it can receive any broadcasts from these translator stations. Since a translator station is in the same coverage area as the main channel, additional mobile control information does not have to be received since it is already stored in mobile control channel memory 175 of FIG. 20.

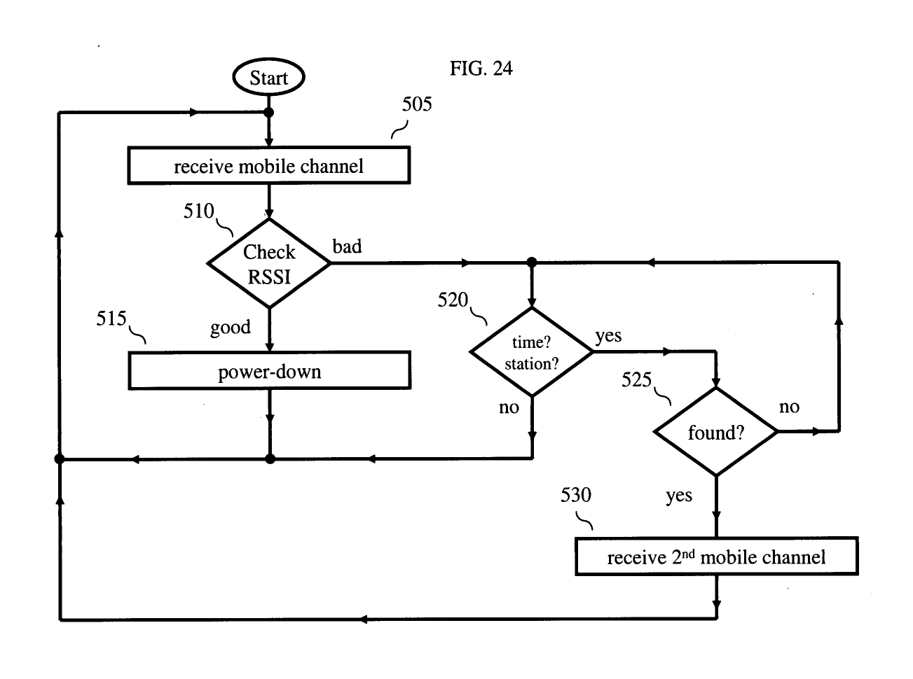

Turning now to FIG. 24, an illustrative flow chart for use in a mobile receiver, e.g., device 300, in accordance with the principles of the invention is shown. In step 505, device 300 receives a mobile burst from a currently tuned DTV channel. In step 510, device 300 (e.g., processor 190) checks the received signal strength indicator (RSSI) via signal 151 of FIG. 20. If the RSSI value is equal to, or above, a predetermined value, e.g., −75 dBm (decibels referenced to one milliwatt), then reception should be good and device 300 enters a power-down mode in step 515 till the next mobile burst is scheduled to be received, e.g., in step 505. However, if the RSSI value is below the predetermined value, then reception is determined to be bad. In this case, device 300 in accordance with the principles of the invention, attempts to locate an associated channel (e.g., either an adjacent coverage area or a translator station) for recovery of the content for the selected channel. In particular, in step 520, device 300 checks if there is enough idle time left and if an associated station exists (as defined in Translator Table 280 or Network Table 280. If there is not enough idle time or there is no associated station, device 300 goes to step 505. However, if there is enough idle time and there is an associated station, then device 300 attempts to locate the associated station in step 525. If no associated station was found, e.g., device 300 was not within range of a translator station or within an overlapping region, then device 300 again checks in step 520 if there is enough idle time to continue looking for another associated station. On the other hand, if an associated station was found, then device 300 receives the 2^{nd} mobile channel in step 530 and then continues with step 505.

In view of the above, during the time a mobile receiver would normally shut down to save power (i.e., the idle time), the mobile receiver tunes to an associated station and attempts to find the same program. Mobile data from the main channel is stored in mobile data buffer 260 of FIG. 20 and if the program from the associated station is found, a second buffer can be established in the mobile receiver (e.g., mobile data buffer 265), and if packets are lost from one coverage area, packets from the other coverage area are checked to see if they can replace the missing/erroneous packets (e.g., via signals 261 and 262). It should be noted that the time slicing period is on the order of a second. As such, RF propagation delay issues are not relevant over the distances involved in a broadcaster's coverage area. In another embodiment of the invention, the receiver combines the received data of the same network program from the current coverage area and the adjacent coverage areas to reliably recover the packets of the network program. One possible combining method is the maximum ratio combining (MRC). It should be noted that although the inventive concept was illustrated in the context of an adjacent network and translator station, both are not required. In fact, only an associated station is required—where the station has associated content.

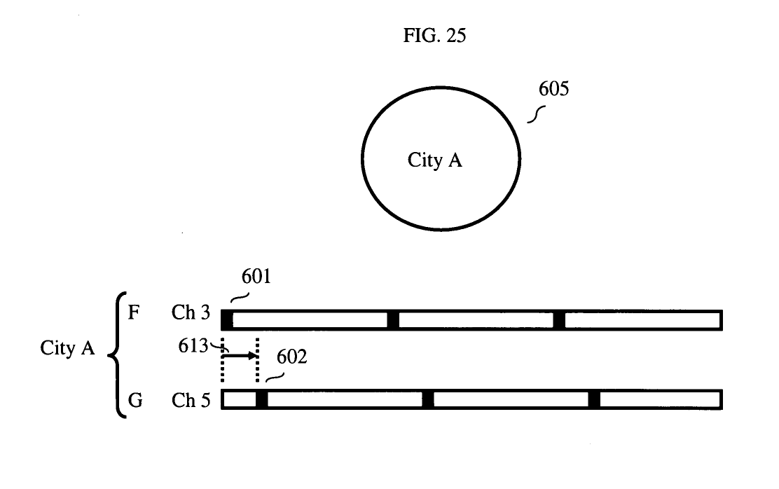

Indeed, by insuring orthogonal time and/or frequency relationships between mobile/handheld broadcasts, other benefits can be obtained. For example, and in accordance with the principles of the invention, a program guide for all channels can be formed if all broadcasters are synchronized. This is illustrated in FIG. 25 where for a coverage area 605 there are two broadcasters, one broadcaster (network F) associated with channel 3 and the other broadcaster (network G) associated with channel 5. As can be observed from FIG. 25, the transmission of mobile burst 602 for channel 5 is delayed by time delay 613 with respect to the transmission of mobile burst 601 for channel 3. As such, it is possible for a mobile receiver to collect metadata (e.g., a program guide comprising event (show) information such as start time, duration, title and description, etc.) and other information from multiple sources by synchronizing the transmission of information from these sources separated in time and frequency. Again, the key benefit to this time sliced approach is that the receiver needs only one demodulator—it dynamically jumps from channel to channel within the idle time of the main program. This jumping only takes place on a minimum duty cycle, to gather program guide, or perhaps to gather other data services from other broadcasters (e.g., a non-real-time program (NRT)). If broadcasters offer multiple channels, program guide information should be offered on the time-slice that least overlaps other broadcasters.

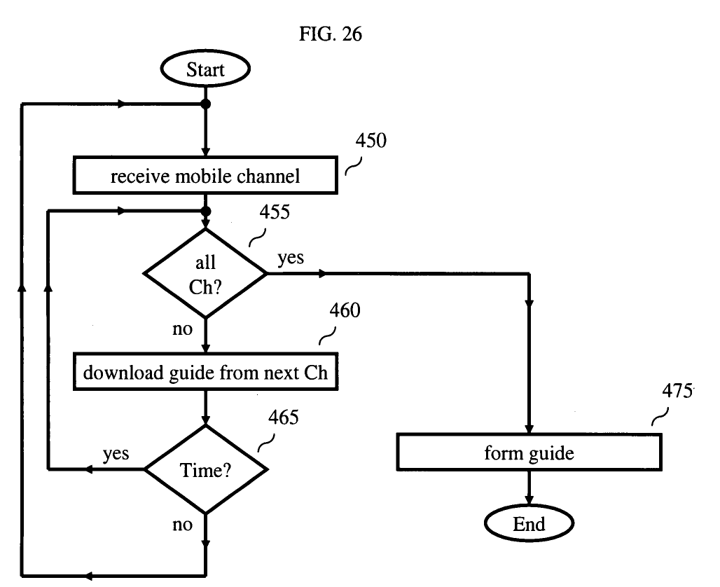

Referring now to FIG. 26, an illustrative flow chart for use in a mobile receiver, e.g., device 300, in accordance with the principles of the invention is shown. In step 450, device 300 tunes to the current channel to receive the current program (which includes program guide information for the current channel). In step 455, device 300 checks to see if all channels have been checked for program guide information. The number of available mobile DTV channels is typically known a priori to the mobile receiver, e.g., upon doing an initial scan in a coverage area. If all the channels have not yet been checked, then device 300 switches to the next channel and downloads program guide information in step 460. In step 465, device 300 checks if enough idle time is left to continue looking for program guide information. If enough time is left, device 300 returns to step 455 and checks the next channel. However, if there is not enough idle time left, then device 300 goes back to step 455 to wait for the next mobile burst from the currently tuned mobile channel. Once it is determined in step 455 that all the mobile DTV channels have been checked device 300 forms a program guide that comprises program guide information from each of the channels in step 475. As a result, the mobile receiver can download program guide information to form a complete program guide even though the user is listening to a program on the currently tuned channel.

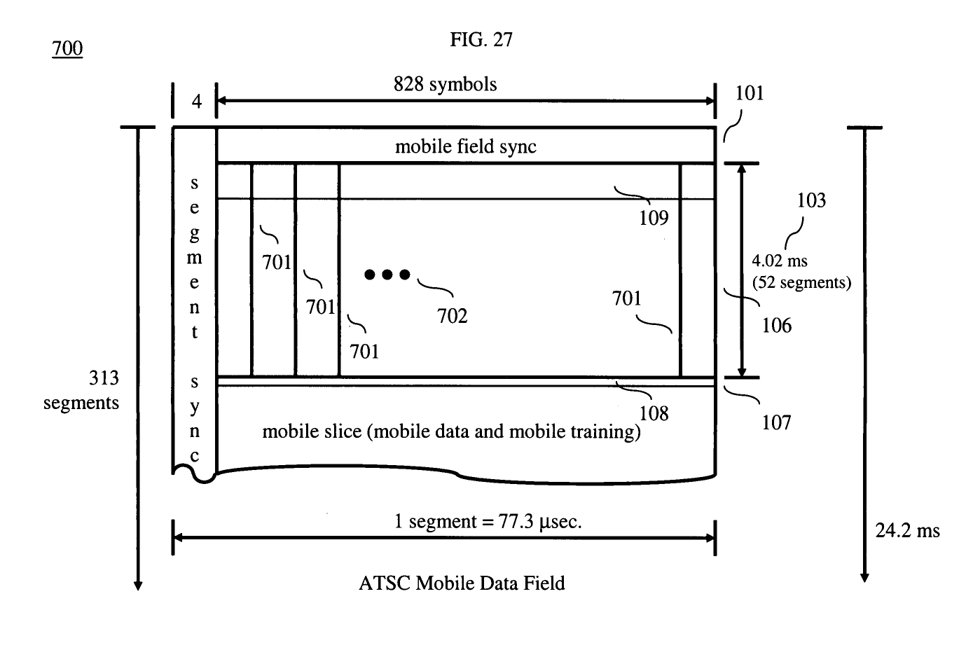

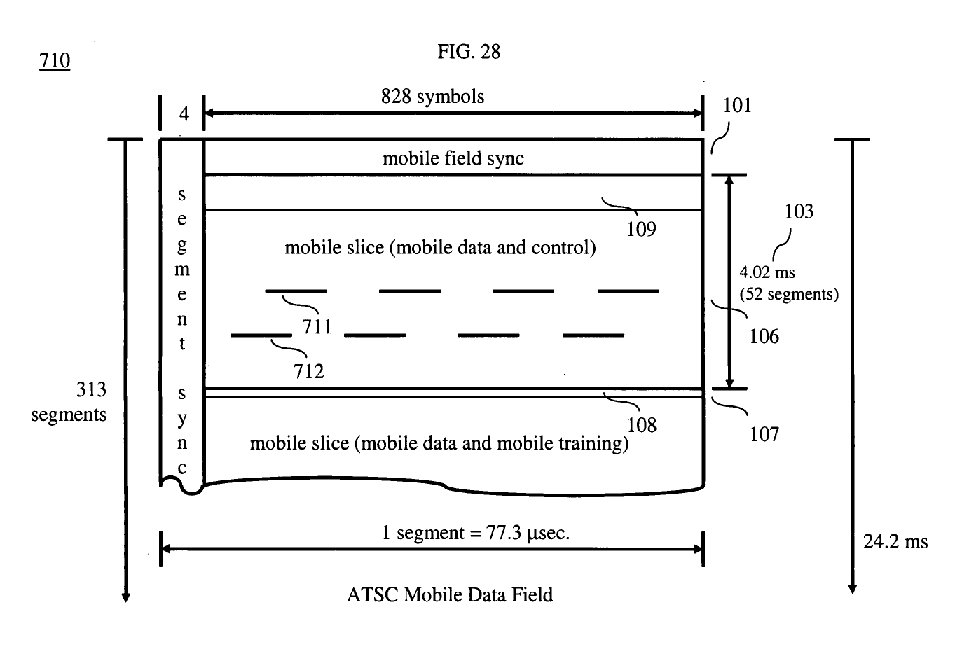

Although training was illustrated in the context of a contiguous burst, the inventive concept is not so limited. For example, training data can be inserted into packets at predetermined symbol positions before interleaving as illustrated in FIG. 27 by vertical black lines 701 (the training data) extending across a mobile data field 700 as represented by ellipsis 702. After interleaving, this results in the training being punctured 4 times across a mobile packet. This is illustrated in FIG. 28 for mobile data field 710 (after interleaving), for just two mobile packets in order to simply the figure, i.e., mobile training data 711 is punctured four times across a packet and mobile training data 712 is punctured four times across another packet. For example, the use of punctured training placed between the field sync and the first full packet length mobile training burst is a further aid in tracking dynamic channel conditions.

In view of the above, the foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied in one or more integrated circuits (ICs). Similarly, although shown as separate elements, any or all of the elements may be implemented in a stored-program-controlled processor, e.g., a digital signal processor, which executes associated software, e.g., corresponding to one or more of the steps shown in, e.g., FIG. 21, etc. Further, although some of the figures may suggest the elements are bundled together, the inventive concept is not so limited, e.g., the elements of device 300 of FIG. 19 may be distributed in different units in any combination thereof. For example, receiver 300 of FIG. 19 may be a part of a device, or box, such as a set-top box that is physically separate from the device, or box, incorporating display 390, etc. Also, it should be noted that although described in the context of terrestrial broadcast (e.g., ATSC-DTV), the principles of the invention are applicable to other types of communications systems, e.g., satellite, Wi-Fi, cellular, etc. Indeed, even though the inventive concept was illustrated in the context of mobile receivers, the inventive concept is also applicable to stationary receivers. It is therefore to be understood that numerous modifications may be made to the illustrative embodiments and that other arrangements may be devised without departing from the spirit and scope of the present invention as defined by the appended claims.

1. Apparatus comprising:
a mobile digital television data source for providing mobile data;
a mobile training data source for providing mobile training data; and
a mobile training data inserter, located before an interleaver, for inserting the mobile training data into mobile packets conveying the mobile data in such a way that after interleaving the mobile training data is only conveyed in K contiguous mobile packets, where K>0.

2. The apparatus of claim 1, wherein the mobile training data inserter inserts training data such that after interleaving the training data is punctured a plurality of times in a mobile packet.

3. The apparatus of claim 1, wherein the mobile training data inserter operates in accordance with K modes.

4. The apparatus of claim 1, further comprising
a transmitter for transmitting a digital multiplex representing a sequence of data fields, every M data fields having a mobile burst comprising a plurality of mobile slices for conveying the mobile packets, where M>0; and wherein the mobile training data occurs after the first mobile slice.

5. The apparatus of claim 4, wherein the digital multiplex represents an Advanced Television System Committee Digital Television signal.

6. A method comprising:
providing mobile data;
providing mobile training data; and
inserting the mobile training data into mobile packets conveying the mobile data in such a way that after interleaving the mobile training data is only conveyed in K contiguous mobile packets, where K>0.

7. The method of claim 6, wherein the inserting step inserts training data such that after interleaving the training data is punctured a plurality of times in a mobile packet.

8. The method of claim 6, further comprising
transmitting a digital multiplex representing a sequence of data fields, every M data fields having a mobile burst comprising a plurality of mobile slices for conveying the mobile packets, where M>0; and wherein the mobile training data occurs after the first mobile slice in the K contiguous packets.

9. The method of claim 8, wherein the digital multiplex represents an Advanced Television System Committee Digital Television signal.

10. Apparatus comprising:
a memory for storing mobile control channel information, wherein the mobile control channel information comprises a training mode value for determining a training mode;
a demodulator for demodulating a received signal for providing a demodulated signal representing a sequence of data fields, every M data fields having a mobile burst comprising a plurality of mobile slices for conveying mobile packets, where M>0; and wherein mobile training data occurs after the first mobile slice in K contiguous packets; and
a processor for setting a training mode of the demodulator in accordance with the training mode value.

11. The apparatus of claim 10, wherein the mobile training data also is punctured a plurality of times in a mobile packet.

12. The apparatus of claim 10, wherein the received signal represents an Advanced Television System Committee Digital Television signal.

13. A method comprising:
storing mobile control channel information, wherein the mobile control channel information comprises a training mode value for determining a training mode;
demodulating a received signal for providing a demodulated signal representing a sequence of data fields, every M data fields having a mobile burst comprising a plurality of mobile slices for conveying mobile packets, where M>0; and wherein mobile training data occurs after the first mobile slice in K contiguous packets; and
setting a training mode of the demodulator in accordance with the training mode value.

14. The method of claim 13, wherein the mobile training data also is punctured a plurality of times in a mobile packet.

15. The method of claim 10, wherein the received signal represents an Advanced Television System Committee Digital Television signal.
